(19) United States
(12) Patent Application Publication
(10) Pub. No.: US 2017/0009615 A1
(43) Pub. Date: Jan. 12, 2017

(54) CAMSHAFT ADJUSTER

(71) Applicant: SCHAEFFLER TECHNOLOGIES AG & CO. KG, Herzogenaurach (DE)

(72) Inventor: Holger BRENNER, Obermichelbach (DE)

(21) Appl. No.: 15/113,135

(22) PCT Filed: Nov. 20, 2014
(86) PCT No.: PCT/DE2014/200649

§ 371 Date: Jul. 21, 2016

(30) Foreign Application Priority Data
Jan. 30, 2014 (DE) 10 2014 201 608.8

(51) Int. Cl. F01L 1/46; F16B 37/12; F16B 39/282; F01L 1/344

(52) U.S. Cl. CPC F01L 1/46; F01L 1/3442; F16B 37/122; F16B 39/282; F01L 2001/34479

(57) ABSTRACT

A camshaft adjuster including a stator and a rotor, wherein the stator and the rotor are arranged such as to be able to rotate relative to one another, the camshaft adjuster has a cover which is connected to the stator or to the rotor such as to rotate therewith, and wherein the stator an/or the rotor and/or the cover has a through-opening which is at least partially penetrated by a screw, wherein the camshaft adjuster has a threaded bushing which is inserted in the through-opening and which includes a tubular piece having an internal screw thread and a radial collar arranged at one end of the tubular piece, wherein the screw engages in the threaded bushing, the threaded bushing has a bearing face which is arranged in the transition from the radial collar to the tubular piece and which is oriented at an angle to a longitudinal axis of the tubular piece, and the threaded bushing bears with the bearing face against a correspondingly shaped counterface of the stator an/or of the rotor and/or of the cover.

The present invention relates to a camshaft adjuster, including a stator and a rotor, the stator and the rotor being rotatably situated relative to each other, the camshaft adjuster having a cover which is rotatably fixedly connected to the stator or the rotor, and the stator and/or the rotor and/or the cover having a through-opening, which is at least partially penetrated by a screw.

### BACKGROUND

A generic camshaft adjuster is known, for example from DE 10 2006 022 219 A1. In its basic configuration, the camshaft adjuster includes a stator which is drivable by a crankshaft and a rotor which is rotatably fixedly connectable to the camshaft. A chain drive or a belt drive may be formed between the stator and the crankshaft for the purpose of driving the stator.

An annular space is generally provided for the camshaft adjuster between the stator and the rotor, which is divided into a plurality of working chambers by stator webs, which are rotatably fixedly connected to the stator and project radially inwardly, the working chambers each being divided into two pressure chambers by a vane which projects radially outward from the rotor core. The camshaft adjuster is preferably a hydraulic camshaft adjuster. Depending on the application of a pressure medium to the pressure chambers, the rotor is adjusted with respect to the stator, and the camshaft is adjusted with respect to the crankshaft, in the “advance” or “retard” direction. The camshaft adjuster is thus used to set a relative angular position of the camshaft with respect to the crankshaft.

A camshaft adjuster of this type is also known, for example from DE 10 2008 017 688 A1. The camshaft adjuster includes a rotor which is rotatably situated with respect to a stator, the stator being in drive connection to the crankshaft, and the rotor being rotatably fixedly connected to the camshaft. The camshaft adjuster is limited in the axial direction on each front side by a cover. Multiple screws pass through the one cover, the stator and the other cover, on which one threaded mating element is mounted for each screw axially on the outside. The particular screw engages therewith to clamp the cover to the stator and to seal the annular space. The stator, the rotor and the two covers thus delimit the multiple working chambers and pressure chambers. The threaded mating elements projecting over the cover and with which the screws engage are a disadvantage of this specific embodiment. Due to these threaded mating elements, the camshaft adjuster requires a correspondingly large installation space. In addition, the screw pretensioning forces needed for the tightness of the cover with respect to the stator are introduced directly axially into the particular adjacent cover. These forces may result in an increased cover deformation during operation and thus a leaking of pressure medium from the camshaft adjuster.

It is an object of the present invention to provide a particularly compact and pressure medium-tight camshaft adjuster.

According to one basic idea of the present invention, it is proposed that the camshaft adjuster has a threaded bushing inserted into the through-opening, which includes a tube piece having a female thread and a radial collar situated on one end of the tube piece, the screw engaging with the threaded bushing, the threaded bushing having a contact surface, which is situated in the transition between the radial collar and the tube piece and is obliquely oriented to a longitudinal axis of the tube piece, and the threaded bushing abutting a correspondingly shaped mating surface of the stator and/or the rotor and/or the cover via the contact surface. The longitudinal axis of the tube piece preferably corresponds to the longitudinal axis of the threaded bushing. The contact surface may therefore be formed at an acute angle to the longitudinal axis.

The camshaft adjuster is preferably delimited in the axial direction on each front side by a cover. In this case, the stator, the rotor and the two covers determine multiple working chambers, each of the working chambers being divided into two oppositely acting pressure chambers with the aid of a vane. To achieve a tightness of the camshaft adjuster, the stator and the at least one cover are usually clamped against each other with the aid of screws. Multiple screws pass through the stator and extend into the at least one cover. The particular end of a screw engages with a threaded bushing according to the present invention, which is preferably inserted into a through-opening of the cover. The at least one cover and the stator may thus be clamped against each other. The threaded bushing preferably has a cylindrical outer surface and a cylindrical inner surface and a female thread for the screw. The threaded bushing may be designed to be open on both sides or open on only one side.

To provide a preferably compact camshaft adjuster, the threaded bushing is preferably inserted, according to the present invention, into the through-opening, preferably into the through-opening of the cover. At least the tube piece of the threaded bushing thus engages with the corresponding through opening. The female thread of the tube piece is thus shifted into the area of the through-opening. The latter is preferably an installation space belonging to the cover and/or the stator. The threaded bushing or the screw connection made up of the screw and the threaded bushing therefore requires only a minimum axial installation space.

The fact that the threaded bushing abuts the correspondingly shaped mating surface of the stator and/or the rotor and/or the cover via the contact surface ensures that the threaded bushing assumes a predetermined axial position, which is advantageous for a series assembly process.

Additional advantages result from the design of the threaded bushing having the oblique contact surface in the transition between the radial collar and the tube piece. The radial collar and the corresponding transition to the tube piece thus permit higher screw forces, due to the enlarged material cross section. Axial forces are also correspondingly obliquely introduced into the cover from a screw pretensioning force via the mating surface, due to the obliquely oriented contact surface of the threaded bushing. As a result, the cover undergoes less deformation in the screwed state, which results in fewer camshaft adjuster leaks. The threaded bushing is also loaded by smaller bending moments, due to the obliquely oriented contact surface, which additionally results in a higher transmittable axial force. Similar advantages result if the threaded bushing is inserted into a through-opening of the stator or the rotor.

The camshaft adjuster may also be particularly precisely mounted. A centering effect is generated, due to the obliquely oriented contact surface of the threaded bushing and the correspondingly shaped mating surface of the stator, rotor and/or cover. For example, if the threaded bushing is inserted into a through-opening of the cover, and the screw, which also penetrates a through-opening of the stator, engages with the threaded bushing, a centering of the cover with respect to the stator occurs when the corresponding screw connection is tightened. An additional alignment or positive guidance of the screw or the cover and the stator is therefore no longer necessary. Similar advantages result if other parts of the camshaft adjuster are connected to each other with the aid of a corresponding screw connection.

The threaded bushing according to the present invention may be provided multiple times. One through-opening is preferably present for each threaded bushing. Ideally, each threaded bushing is in engagement with a screw; alternatively, however, only selected threaded bushings may come into engagement with a screw.

One advantageous embodiment of the camshaft adjuster is characterized in that the radial collar is countersunk in the through-opening. A camshaft adjuster of this type is particularly compact and requires a minimum, longitudinally axial installation space. The threaded bushing is advantageously inserted into the through-opening with the tube piece first. Due to the fact that the radial collar is countersunk in the through-opening, the threaded bushing no longer projects over the side of the cover, the stator or the rotor from which the threaded bushing was inserted. As a result, components may be mounted on the aforementioned side, directly abutting each other without spacing elements such as spacing washers. If the threaded bushing is inserted into the through-opening of the cover, adjacent components, such as a spiral spring or trigger wheel, may be mounted in a flush manner without additional cover designs or additional spacing elements.

One advantageous embodiment of the camshaft adjuster is characterized in that the radial collar is situated flush with an outer flange side of the stator, the rotor or the cover. This embodiment of the camshaft adjuster is also particularly compact and requires only a minimum, longitudinally axial installation space. The similar advantages explained with regard to the previous embodiment also apply. Moreover, the flush arrangement offers a particularly even and/or contour-free surface on the flange side. This reduces the risk of passing parts becoming stuck on or rubbing against the through-opening.

One advantageous embodiment of the camshaft adjuster is characterized in that the threaded bushing is fastened to the adjacent stator and/or rotor and/or cover by a form, force or integral fit. In principle, the threaded bushing may therefore be prevented from rotating with respect to the stator and/or the rotor and/or the cover. The anti-rotating device may be designed with the aid of an interference fit between the threaded bushing and the through-opening of the cover, stator and/or rotor. A “co-rotation” of the threaded bushing is thus advantageously prevented when the screw is screwed into the threaded bushing. A separate counter-holding tool for preventing a rotation of the threaded bushing during assembly may be omitted.

One advantageous embodiment of the camshaft adjuster is characterized in that the threaded bushing has a male thread which is oppositely acting from the female thread, for example a female thread designed as a right-hand thread and a male thread designed as a left-hand thread (or vice versa). The threaded bushing may be connected to the cover, the stator or the rotor with the aid of the male thread.

One advantageous embodiment of the camshaft adjuster is characterized in that the threaded bushing has radial external teeth and/or grooves and/or knurling. The through-opening may have inner projections which are correspondingly shaped to the teeth, grooves and/or knurling. The threaded bushing may engage with these projections via the teeth or knurling (or vice versa). This embodiment is thus suitable for fastening the threaded bushing in the cover, stator or rotor. This embodiment is furthermore suitable for preventing a “co-rotation” of the threaded bushing when the screw is screwed into the threaded bushing.

In another advantageous embodiment, the radial collar of the threaded bushing may have an angular outer contour, in particular a hexagon head or the like. If the component with the mating surface has a groove which is correspondingly shaped to the angular outer contour of the radial collar, the radial collar may engage with the corresponding groove. The threaded bushing is thus prevented from “co-rotating” by the groove when the screw is screwed into the threaded bushing.

One advantageous embodiment of the camshaft adjuster is characterized in that the threaded bushing has grooves for the engagement of an assembly tool on a front side of the radial collar. The assembly tool may engage with the groove to prevent a “co-rotation” of the threaded bushing when the screw is screwed into the threaded bushing. A separate fastening of the threaded bushing to the cover, the stator and/or the rotor for preventing the “co-rotation” of the threaded bushing may thus be omitted. This makes it easier to manufacture the camshaft adjuster, since the threaded bushing and the component having the mating surface may be manufactured with a larger manufacturing clearance or with greater manufacturing tolerances. A clearance fit may also arise between the through-opening and the threaded bushing inserted therein. In an embodiment of this type, the position of the cover with respect to the stator and/or the rotor may be advantageously adjusted, for example to set a locking clearance before the cover is fixedly clamped to the stator or the rotor by the screws. Similar advantages apply to a clamping connection between other components which may be clamped by the screw connection.

One advantageous embodiment of the camshaft adjuster is characterized in that an angle between the obliquely oriented contact surface and a longitudinal axis of the tube piece is designed in such a way that the threaded bushing abuts the mating surface via a radial outer area of the contact surface. An outer annular area of the contact surface may thus abut the mating surface. By adapting the angle of the contact surface of the threaded bushing to an angle of the mating surface of the cover, the stator and/or the rotor, a connection borne on the outer diameter of the threaded bushing may be formed. In other words, the clamping force arising due to the screw connection may be introduced into the cover, the stator and/or the rotor from the radial outer edge or ring of the radial collar. This results in a defined and predeterminable contact between the threaded bushing and the component having the mating surface, preferably the cover. This is advantageous for a stable series screwing process, since the defined contact makes it possible to achieve a constant friction coefficient between the contact surface and the mating surface.

One advantageous embodiment of the camshaft adjuster is characterized in that the threaded bushing is inserted into the through-opening of the cover. This makes it possible, in particular, to easily insert the threaded bushing, since the cover is accessible from the outside, at least during assembly. The cover may thus be adjusted before the screw fixedly clamps the cover to another component.

One advantageous embodiment of the camshaft adjuster is characterized in that the tube piece of the threaded bushing projects into the through-opening of the stator or the rotor. If the threaded bushing is advantageously inserted without clearance into the through-opening of the stator or the rotor, a precise alignment and/or circumferential positioning of the threaded bushing takes place thereby. If the threaded bushing also passes through a through-opening of the cover with clearance, the cover may be adjusted relative to the stator or rotor in the circumferential direction and/or in the radial direction before the cover is fixedly clamped to the stator or the rotor with the aid of the screw. The through-opening of the cover may have a larger diameter than the diameter of the threaded bushing or its tube piece. The through-opening of the cover element may also be advantageously designed as an elongated hole in the circumferential direction. Alternatively, a smaller clearance may be provided between the threaded bushing and the through-opening of the cover than between the threaded bushing and the through-opening of the stator or the rotor. If the threaded bushing is advantageously inserted into the through-opening of the cover without clearance, the cover mounted on the stator or the rotor may be adjusted in the circumferential direction and/or in the radial direction before the cover is fixedly clamped to the stator or the rotor with the aid of the screw. For this purpose, a clearance is preferably formed between the through-opening of the stator or the rotor and the threaded bushing. The through-opening of the stator or the rotor is advantageously designed as an elongated hole in the circumferential direction.

### BRIEF DESCRIPTION OF THE DRAWINGS

The present invention is explained below on the basis of one preferred specific embodiment with reference to the appended figures.

FIG. 1 shows a schematic sectional representation of a camshaft adjuster according to the present invention;

FIG. 2 shows a schematic front view of the threaded bushing;

FIG. 3 shows a schematic sectional representation of the threaded bushing;

FIG. 4 shows a schematic perspective view of the threaded bushing;

FIG. 5 shows a schematic top view of an outer front side of the cover; and

FIG. 6 shows a schematic sectional representation of the cover.

### DETAILED DESCRIPTION

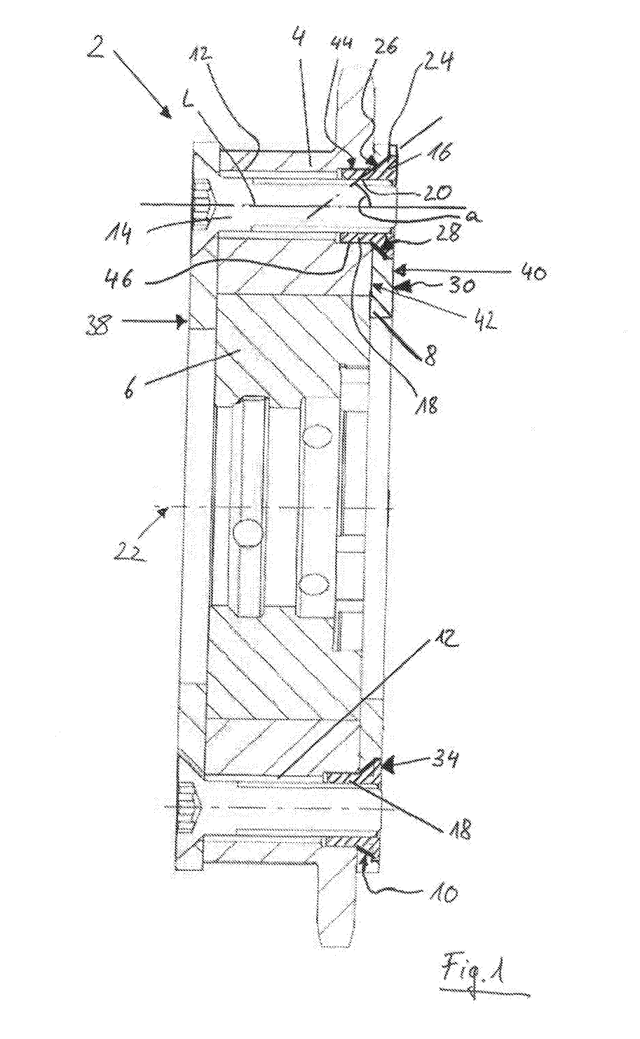

FIG. 1 shows a camshaft adjuster 2, which includes a threaded bushing 16 according to the present invention in a schematic sectional representation. Camshaft adjuster 2 includes a stator 4 and a rotor 6. Stator 4 and rotor 6 are situated coaxially to rotation axis 22 of camshaft adjuster 2, stator 4 and rotor 6 having multiple radially oriented stator webs or vanes, which are not illustrated in greater detail here, stator 4 and rotor 6 forming oppositely acting pressure chambers. Each pressure chamber is defined by a pair made up of a web of the stator 4 and a vane of rotor 6. Hydraulic medium may be applied to the pressure chambers for the purpose of achieving a relative rotation between stator 4 and rotor 6.

Camshaft adjuster 2 furthermore has a cover 8 on each of its front sides 38, 40. A cover 8 prepared for assembly, including inserted threaded bushings 16, is illustrated separately in FIG. 6. To make the explanation easier to understand, reference is made below to one cover 8 in each case, at least one of the two covers 8 or both covers 8 of camshaft adjuster 2 being meant thereby. Cover 8 has a flat and annular design and is situated on a front side 42 of stator 4. Cover 8 is fastened to stator 4 with the aid of at least one screw 14. Screw 14 completely penetrates a through-opening 12 of stator 4, which is designed as a through-bore. Through-opening 12 of stator 4 is situated in a web of stator 4, which is not illustrated in greater detail here.

To fasten cover 8 using screw 14, a threaded bushing 16 is situated between these two components. Threaded bushing 16 in this case is designed as a threaded sleeve which is open on both sides. Threaded bushing 16 furthermore includes a tube piece 18 and a radial collar 24. Radial collar 24 of threaded bushing 16 terminates directly on a front side 34 of threaded bushing 16. Screw 14 penetrates through-opening 10 formed by cover 8 and engages with threaded bushing 16. Screw 14 may alternatively project at least partially into threaded bushing 16 or into through-opening 10 of cover 8, provided that at least two to three thread turns of screw 14 are in engagement with female thread 20 of threaded bushing 16. Threaded bushing 16 abuts a correspondingly shaped mating surface 28 of cover 8 via the contact surface 26. For this purpose, mating surface 28 and contact surface 26 are oriented correspondingly obliquely at an angle a to a longitudinal axis L of through-opening 10 of cover 8. The radial dimensions may also be correspondingly designed. This advantageously ensures that threaded bushing 16 assumes a predetermined longitudinally axial position, which is advantageous for a series assembly process. Axial forces are also correspondingly obliquely introduced into cover 8 from a screw pretensioning force via mating surface 28, due to obliquely oriented contact surface 26 of threaded bushing 16. As a result, cover 8 undergoes less deformation in the screwed state, which results in fewer camshaft adjuster leaks. Threaded bushing 16 is also loaded by smaller bending moments, due to obliquely oriented contact surface 26, which additionally results in a higher transmittable axial force. Moreover, a centering of cover 8 occurs during the assembly of camshaft adjuster 2. Due to the fact that threaded bushing 16 is inserted into a through-opening 10 of cover 8 as well as into a through-opening 12 of the stator, and screw 14, which also penetrates through-opening 12 of stator 4, engages with threaded bushing 16, the centering of cover 8 with respect to stator 4 occurs when the corresponding screw connection is tightened. An additional alignment or positive guidance of screw 14 or of cover 8 and stator 4 is therefore no longer necessary.

To subsequently achieve an improved adjustment, threaded bushing 16 projects at least partially into through-opening 12 of stator 4. A clearance may be formed between cylindrical outer circumferential surface 44 of tube piece 18 of threaded bushing 16 and cylindrical inner circumferential surface 46 of through-opening 12 of stator 4. Due to the predefined clearance, cover 8, including threaded bushing 16, may be mounted on stator 4, a subsequent, precise adjustment being able to take place, in particular in the circumferential direction. The ability to make an adjustment may be used for setting a locking clearance between a locking piston supported in stator 4 and a locking gate formed by cover 8. In such a case, cover 8 is designed as a locking cover.

By “tightening” screw 14, contact surface 26 of radial collar 24 is pressed against mating surface 28 of cover 8, so that cover 8 is pressed against stator 4. In other words, cover 8 is clamped between radial collar 24 and stator 4 via contact surface 26 of radial collar 24. The camshaft adjuster is particularly pressure medium-tight, due to the high transmittable screw force.

FIG. 2 shows a schematic front view of threaded bushing 16. It is apparent therefrom that the maximum outer diameter of radial collar 24 is much larger than the maximum outer diameter of tube piece 18. Tube piece 18 and radial collar 24 are situated coaxially to each other, so that threaded bushing 16 is rotationally symmetrical. As a result, threaded bushing 16 is particularly easy to manufacture.

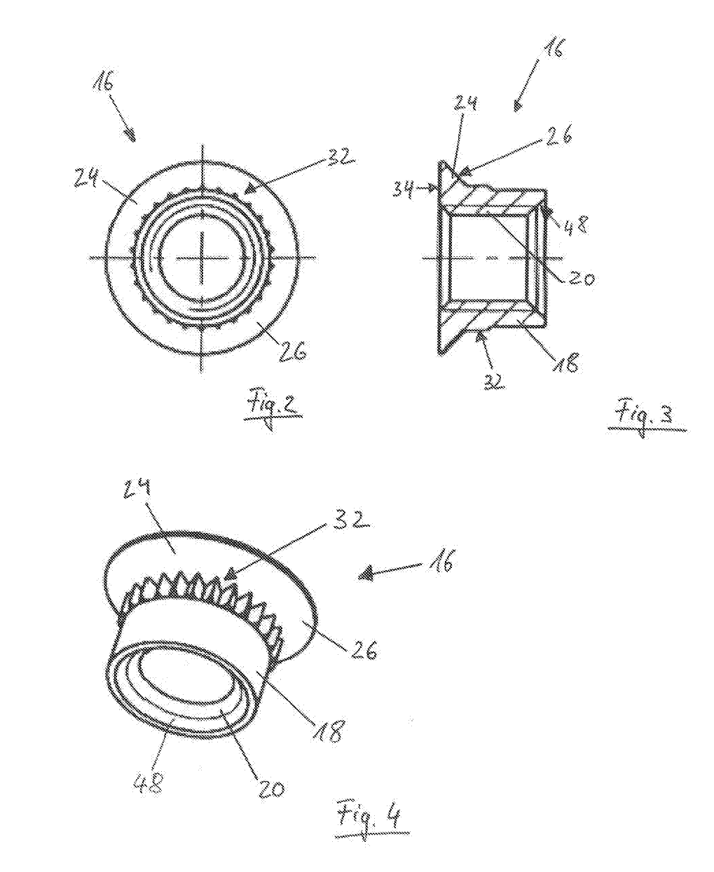

It is apparent from FIG. 3 and FIG. 4 that tube piece 18 has an oblique guide surface 48 on the side facing away from radial collar 24, which is used to guide screw 14 to female thread 20 of threaded bushing 16 during assembly.

It is also apparent from the combined views of FIG. 2 through FIG. 4 that tube piece 18 has teeth 32 adjacent to radial collar 24, which project radially to the outside. Teeth 32 are evenly distributed over the circumference of tube piece 18 in the manner of a toothed wheel. Teeth 32 also form only a limited annular section of tube piece 18, so that a manufacture of threaded bushing 16 may furthermore take place cost-effectively. These teeth 32 are used to engage with corresponding grooves of through-opening 10 of cover 8 when threaded bushing 16 is inserted into through-opening 10 of cover 8. A form fit thus occurs between threaded bushing 16 and cover 8, which prevents threaded bushing 16 from rotating relative to cover 8. A separate assembly tool for preventing threaded bushing 16 from “co-rotating” may be omitted with this embodiment.

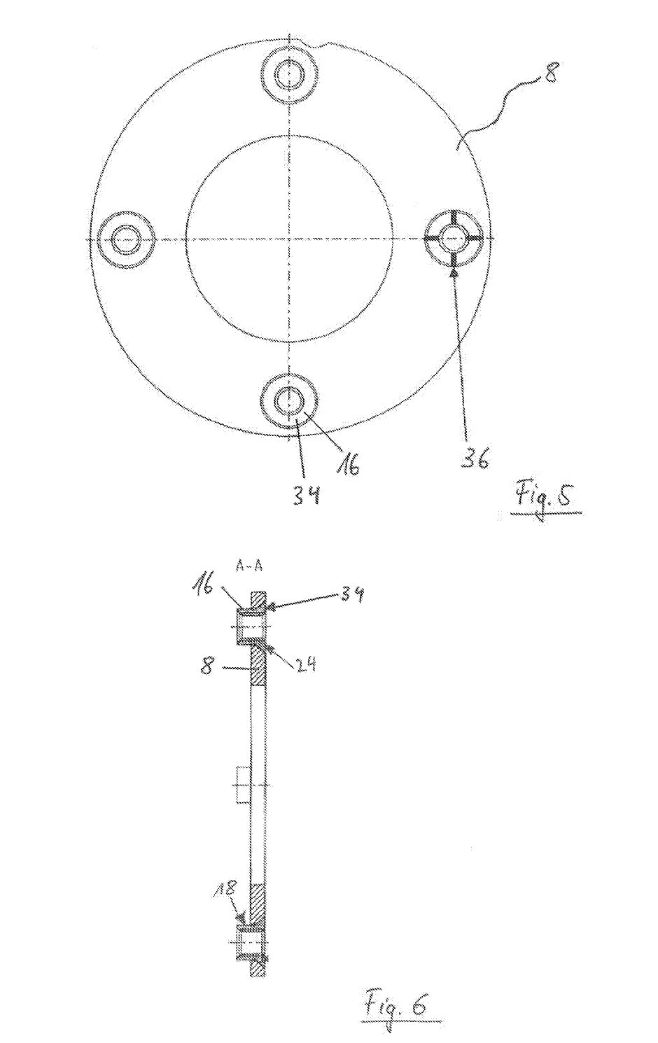

An alternative or supplementary means for preventing threaded bushing 16 from rotating is apparent from FIG. 5. This figure shows cover 8 with threaded bushings 16 inserted into associated through-openings 10, which have grooves 36 on front side 34 of radial collar 24 for the purpose of engaging an assembly tool. A corresponding assembly tool may thus engage with grooves 36 during assembly of camshaft adjuster 2 and prevent threaded bushing 16 from rotating, so that screw 14 may engage with female thread 20 of threaded bushing 16.

### LIST OF REFERENCE NUMERALS

2 camshaft adjuster
4 stator
6 rotor
8 cover
10 through-opening
12 through-opening
14 screw
16 threaded bushing
18 tube piece
20 female thread
22 rotation axis
24 radial collar
26 contact surface
28 mating surface
30 flange side
32 teeth
34 front side
36 groove
38 front side
40 front side
42 front side
44 outer circumferential surface
46 inner circumferential surface
48 guide surface
a angle
L longitudinal axis

What is claimed is:

1-9. (canceled)

10. A camshaft adjuster comprising:
a stator and a rotor rotatably situated relative to each other;
a cover rotatably fixedly connected to the stator or the rotor; and
the stator or the rotor or the cover having a through-opening at least partially penetrated by a screw; and
a threaded bushing inserted into the through-opening and including a tube piece having a female thread and a radial collar situated on one end of the tube piece, the screw engaging with the threaded bushing; the threaded bushing having a contact surface situated in a transition between the radial collar and the tube piece and obliquely oriented with respect to a longitudinal axis of the tube piece, the threaded bushing abutting a correspondingly shaped mating surface of the stator or the rotor or the cover via the contact surface.

11. The camshaft adjuster as recited in claim 10 wherein the radial collar is countersunk in the through-opening.

12. The camshaft adjuster as recited in claim 10 wherein the radial collar is situated flush with an outer flange side of the stator, the rotor or the cover.

13. The camshaft adjuster as recited in claim 10 wherein the threaded bushing is fastened on the adjacent stator or rotor or cover by a form, force or integral fit.

14. The camshaft adjuster as recited in claim 10 wherein the threaded bushing has radial external teeth or grooves or knurling.

15. The camshaft adjuster as recited in claim 10 wherein the threaded bushing has grooves on a front side of the radial collar for the purpose of engaging with an assembly tool.

16. The camshaft adjuster as recited in claim 10 wherein an angle between the obliquely oriented contact surface and the longitudinal axis of the tube piece is designed in such a way that the threaded bushing abuts the mating surface via a radial outer area of the contact surface.

17. The camshaft adjuster as recited in claim 10 wherein the threaded bushing is inserted into the through-opening of the cover.

18. The camshaft adjuster as recited in claim 17 wherein the tube piece of the threaded bushing projects into the through-opening of the stator.
